(19) United States
(12) Patent Application Publication
(10) Pub. No.: US 2012/0156346 A1
(43) Pub. Date: Jun. 21, 2012

(54) Apparatus for Manufacture of Flat Bread and Method for Manufacture the Same

(75) Inventors: Ashot Grigoryan, Northridge, CA (US); Alexander Krayner, ShermOaks, CA (US)

(73) Assignee: A&G BAKERY, INC., North Hollywood, CA (US)

(21) Appl. No.: 12/973,442

(22) Filed: Dec. 20, 2010

(51) Int. Cl. H05B 3/68; A21D 8/06

(52) U.S. Cl. 426/496; 219/450.1

(57) ABSTRACT

A device and method for heating a food product are disclosed. The device contains a support member for supporting a food product in a first position and a second position, a heating mechanism associated with the support member and positioned to heat the support member when the support member is in the first position and in the second position, and another heating mechanism positioned to heat the food product when the food product is in the second position.

### FIELD

The present application relates to an apparatus for the manufacture of flat bread and a method of making such flat bread using a device of the type described herein.

### BACKGROUND

Flat bread is a bread of Middle Eastern origin dating back a number of centuries. In general, flat bread is relatively thin bread having a generally rounded or oval shape. It may be used as a wrapper to enclose other food making up the meal.

Brick ovens have been traditionally used for the production of food substances including pizza, flat breads, traditional breads, and the like. Brick ovens fall into a number of categories including: (1) common deck ovens enhanced with a supplemental ceramic, brick, firebrick, stone, baked clay, transite, quarry tile, or other metallic and non-metallic materials which serve as a baking surface (“hearth”) that is placed on the cooking chamber's floor and sometimes on racks within the cooking chamber; (2) deck ovens designed and manufactured with an incorporated baking chamber floor of a material which serves as a hearth; and (3) custom-built brick ovens which contain a hearth, walls and ceiling of one or more of the above mentioned materials.

Brick ovens are considered by many production personnel, bakers, operators of restaurants and production equipment, and individuals familiar with the art (“bakers”) to produce a product that is superior to that which can be produced in ovens utilizing a conventional, convection or impingement cooking chamber but lacking a hearth. Most commonly, these ovens employ a primary thermostatically controlled heating means of electricity, natural gas, or propane. In some applications, wood or coal is used. However, temperature within the cooking chamber of a wood or coal fired oven is often difficult to control and preheat times are lengthy. New wood-burning brick ovens, featuring a primary heating means via natural gas, electricity or propane with wood incorporated mainly for its visual appeal, have attempted to remedy this shortcoming.

There are many reasons why a brick oven produces superior baked food substances. Superior quality is generally attributed to the fact that food substances are placed directly on a pre-heated hearth. The hearth also has a tendency to absorb moisture during the baking process. Although the food substances are subjected to heat from all sides thereby simultaneously baking from all sides, the most intense and rapid heat transfer takes place from beneath due to the direct contact between the pre-heated hearth and the food substance. This degree of heat transfer cannot be achieved in ovens where direct contact with a pre-heated hearth is not possible.

Other technologies that improve heat transfer include hot air convection cooking and forced hot air impingement, which serve to reduce the cold zone that surrounds food substances. These technologies increase the rate at which heat transfer takes place; however, these technologies still fail to achieve the same rapidity of heat transfer that is achieved via the direct contact with a pre-heated hearth.

The rapid heat transfer that takes place between a pre-heated hearth and food substances results in a reduced bake time and a baking process that effectively causes food substances to bake from the bottom-up.

However, bakers who utilize brick ovens report the task of baking food substances in brick ovens is far more labor intensive than baking with a common deck oven, as more training is required to achieve satisfactory results than is necessary with the common deck oven. A number of shortcomings were cited which explain the increased difficulty of operation.

One such shortcoming is wide fluctuations in hearth temperature. These fluctuations are caused by the placement of food substances directly on the hearth for baking. When a food substance is placed directly on the hearth, the heat transfer that takes place results in a decrease in the temperature of the hearth. When baking is complete and the food substance is removed, the area of the hearth on which baking occurred must be given time to recover its lost energy and return to optimum baking temperature before another food substance can be placed on the same area and baked with a similar result. This is known as recovery time. This recovery process also serves to purge the hearth of any moisture that may have been absorbed during the baking process. In high volume operations, bakers report difficulty remembering which areas of the hearth are in the process of recovery and which areas have recovered to optimum baking temperature. When multiple bakers are involved in production, this process becomes extremely difficult.

Brick ovens also share the commonly reported shortfall of common deck ovens which is the necessity of having to open the door to the baking chamber repeatedly to check food substances baking on the hearth. Due to the rapid transfer of heat from the hearth to food substances as well as varying hearth and ambient air temperatures within the cooking chamber, bakers must make regular observations to ensure a quality product. This is especially prevalent in high volume operations that utilize brick ovens with multiple bakers involved in the baking process at the same time. Furthermore, the increased frequency of opening the oven door results in greater temperature fluctuations within the cooking chamber. The result of this extensive interaction is inconsistent product quality, decreased energy efficiency, and an uncomfortable, hot work environment. Increased risk of injury also results from the intensive interaction with the oven. Because the process of checking for doneness of food substances is repeated so often, some brick oven manufacturers have eliminated the oven door. Bakers claim the risk of burns is further increased by the lack of a door due to the direct exposure to the interior cooking chamber while energy efficiency is decreased.

The present disclosure overcomes all of the above discussed problems by providing a method and an apparatus for producing thin, flat bread with the same quality and appeal of a product cooked by a hearth baking process. The present disclosure enables making of such bread in a rapid and convenient manner by even the most unskilled of bakers.

### BRIEF DESCRIPTION OF THE FIGURES

FIGS. 1a-b depict an exemplary embodiment of an apparatus according to present disclosure;

FIG. 2 depicts another view of the exemplary embodiment of the apparatus according to present disclosure as shown in FIGS. 1a-b;

FIG. 3 depicts another view of the exemplary embodiment of the apparatus according to present disclosure as shown in FIGS. 1a-b;

FIG. 4 depicts an exemplary embodiment of a heating mechanism;

FIG. 5 depicts another view of the exemplary embodiment of the apparatus according to present disclosure as shown in FIGS. 1a-b;

FIG. 6 depicts another view of the exemplary embodiment of the apparatus according to present disclosure as shown in FIGS. 1a-b;

FIGS. 7a-d depict an exemplary embodiment of a nozzle;

FIGS. 8a-d depict an exemplary embodiment of a cover;

FIG. 9 depicts another exemplary embodiment of an apparatus according to present disclosure;

FIG. 10 depicts an exemplary embodiment of a heating assembly for the apparatus depicted in FIG. 9;

FIGS. 11a-b depict another exemplary embodiment of an apparatus according to present disclosure;

FIG. 12 depicts an exemplary embodiment of a heating assembly for the apparatus depicted in FIG. 11;

FIG. 13 depicts an exemplary embodiment of a process to prepare food substances.

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

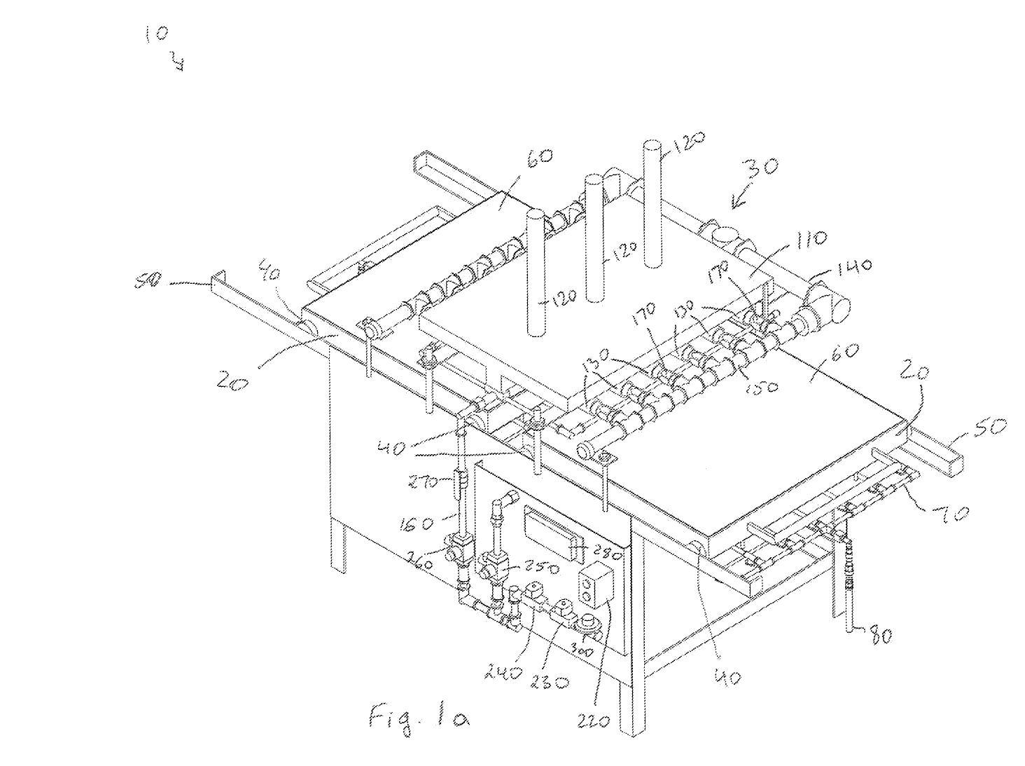

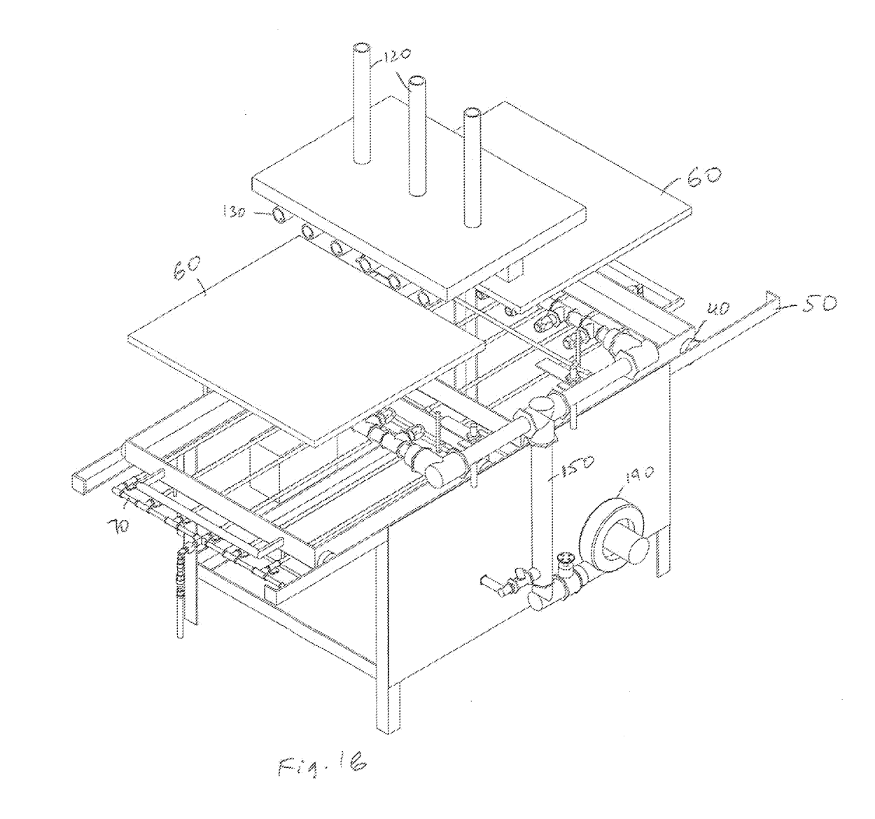

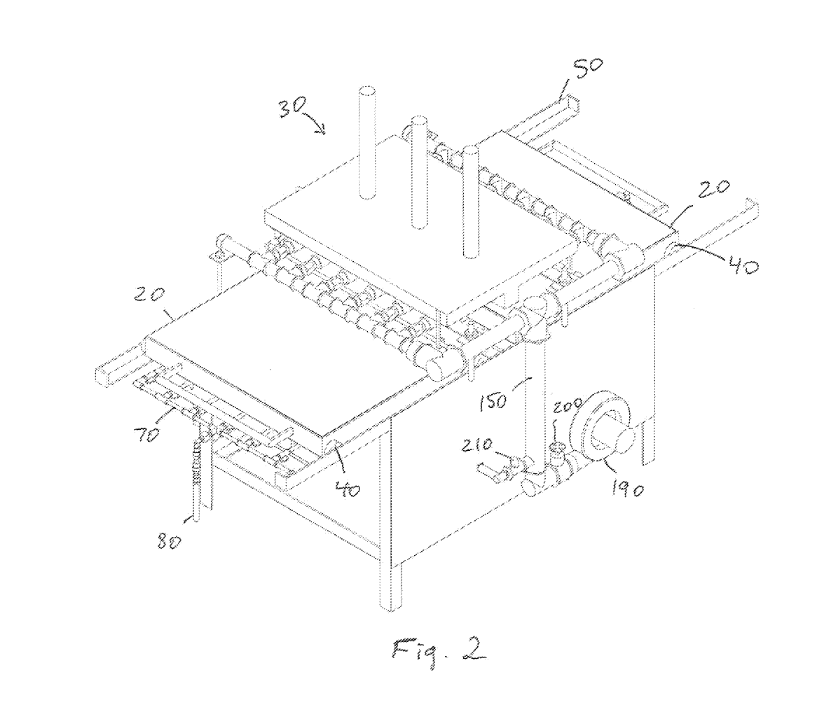

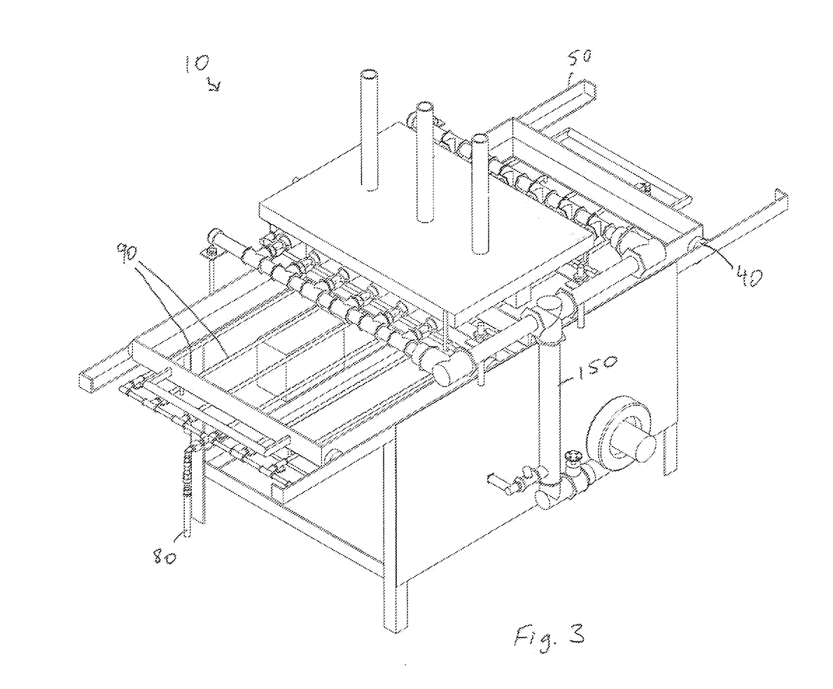

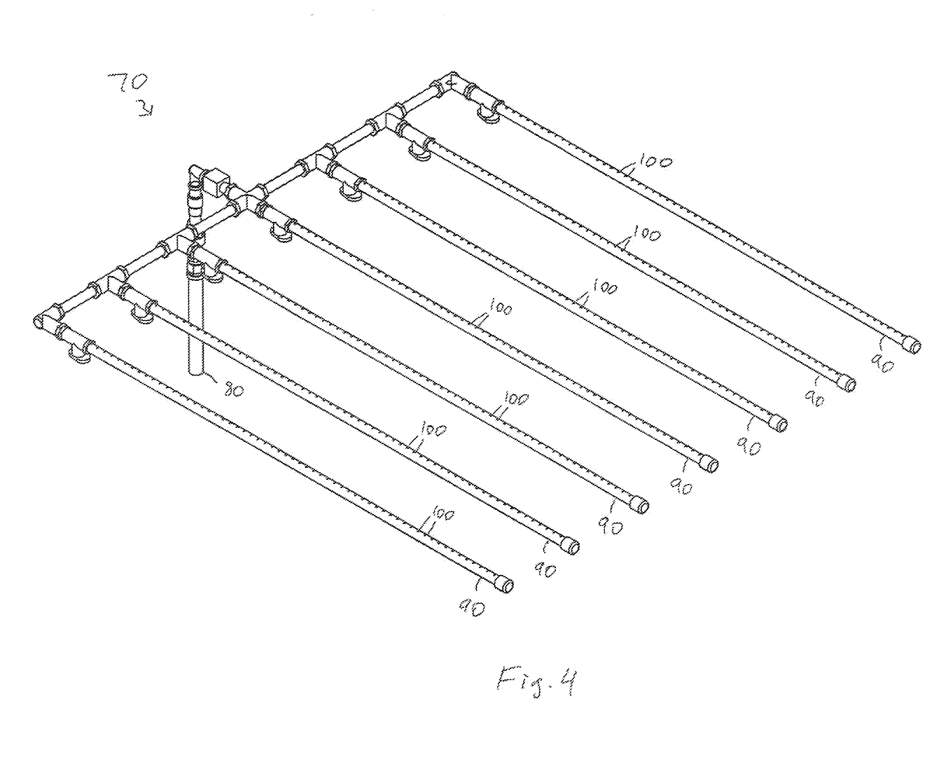

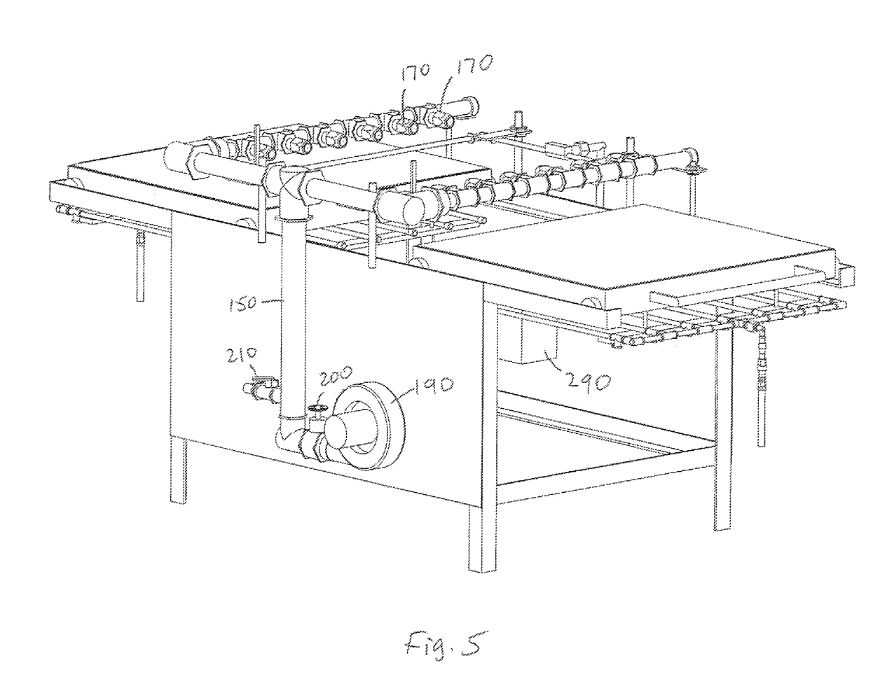

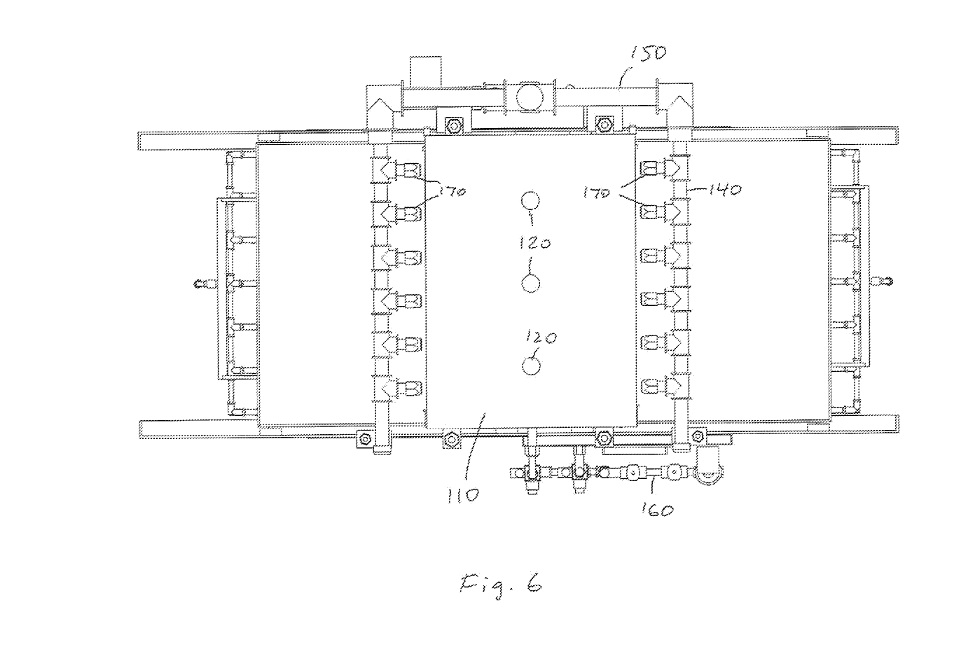

In one exemplary embodiment, apparatus 10, shown in FIGS. 1a-b, may be used to prepare food substances and/or food products including, but not limited to, pizza, flat breads, traditional breads, and the like according to the present disclosure. Apparatus 10 may have heating assemblies 20 and a heating assembly 30. Although two heating assemblies 20 are depicted in FIG. 1, it is to be understood that apparatus 10 may operate with only one heating assembly 20.

As shown in FIGS. 1a-b and 2, the exemplary apparatus 10 may be configured to allow the heating assemblies 20 to move with respect to the stationary heating assembly 30 using wheels 40 on the frame 50. In another exemplary embodiment (not shown), apparatus 10 may be configured to allow the heating assembly 30 to move with respect to stationary heating assemblies 20.

The heating assemblies 20 may contain a support surface 60 for supporting food during the preparation process and a heating mechanism 70 dedicated to heating the support surface 60 regardless of where the heating assembly 20 is with respect to the heating assembly 30. The heating mechanism 70 may be any means of heating known to those of ordinary skill in the art including fire, hot coals, infrared, electric, gas, convection and hot air impingement, among others and is possibly thermostatically controlled.

In one exemplary embodiment, the heating mechanism 70, as shown in FIGS. 1a-b, 2, 3 and 4, heats the support surface 60 by supplying gas mixed with air through hose 80 to pipes 90. As the gas and air mixture escapes through the openings 100 of the pipes 90, the gas and air mixture may be ignited using, for example, a gas pilot light as known in the art. Once the gas and air mixture is ignited, the resulting fire constantly heats the support surface 60 allowing for the most intense and rapid heat transfer to take place as the food product is placed on the support surface 60. This rapid heat transfer that takes place between the constantly heated support surface 60 and the food product further results in a reduced bake time and a baking process that effectively causes food substances to start baking from the bottom-up before applying heat from the heating assembly 30.

The heating assembly 30 may contain a heating mechanism 140 configured to heating food product on the support surface 60 as the heating assembly 20 is positioned under the heating assembly 30. The heating mechanism 140 may be any means of heating known to those of ordinary skill in the art including fire, hot coals, infrared, electric, gas, convection and hot air impingement, among others and is possibly thermostatically controlled.

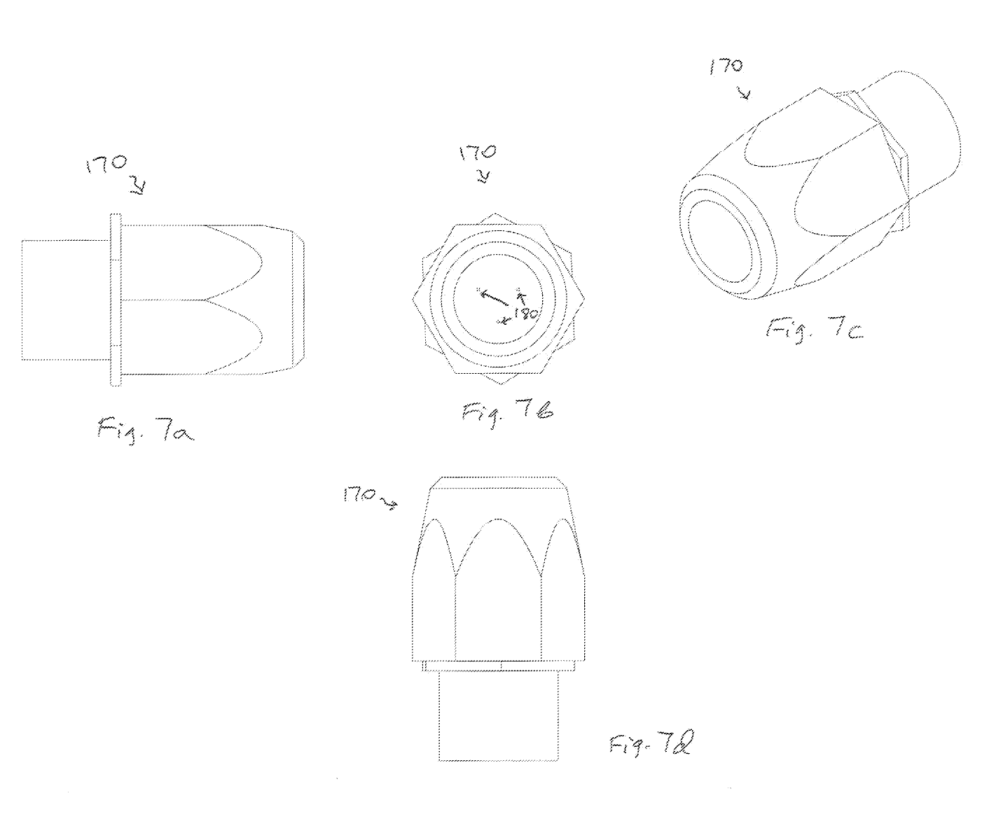

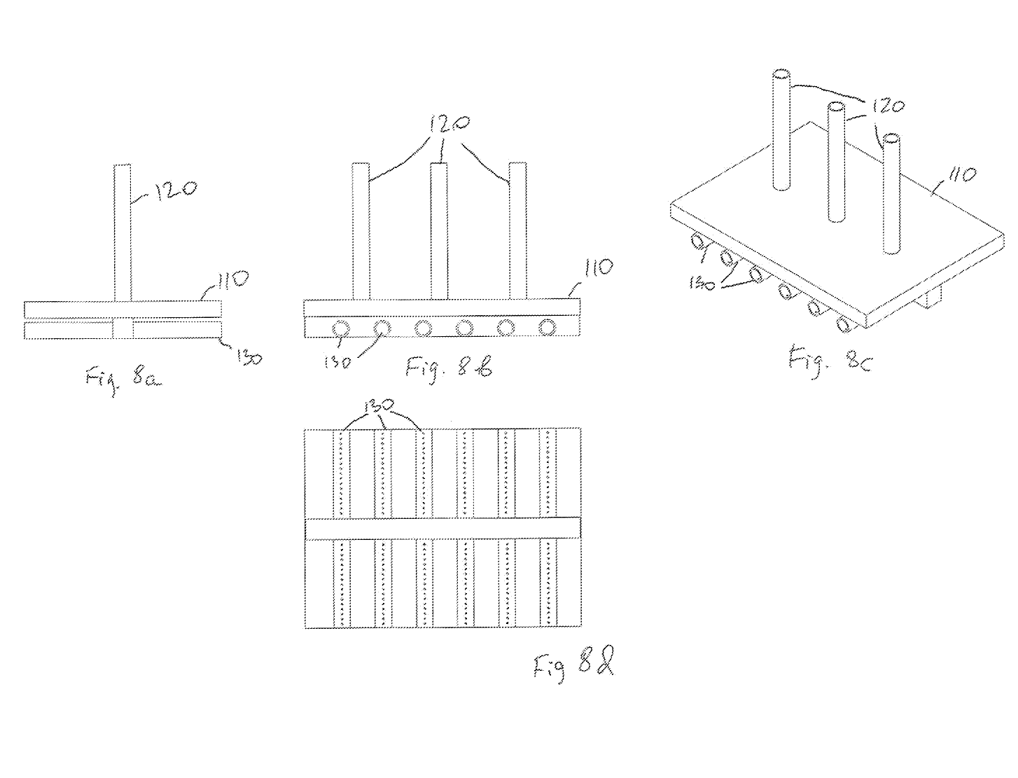

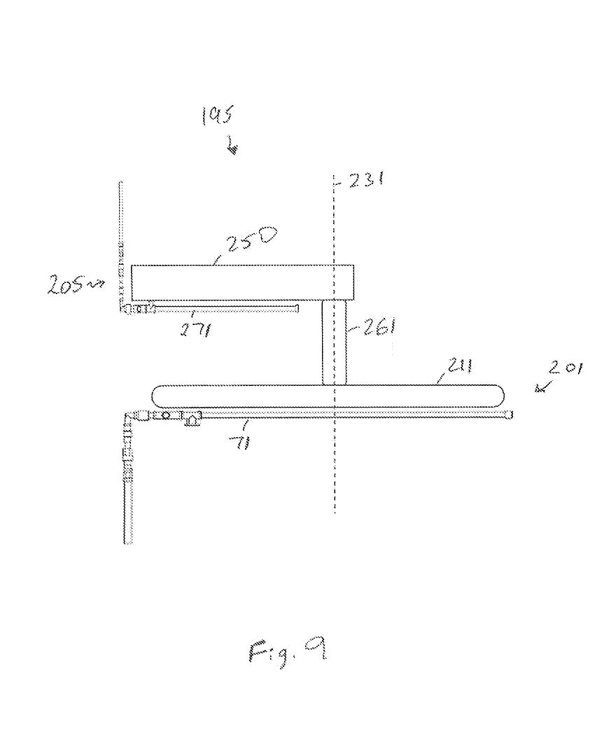

In one exemplary embodiment, the heating assembly 30, as shown in FIGS. 1a-b, 5 and 8a-d, may contain a cover 110, exhaust pipes 120, heating tubes 130, gas supply system 150, and gas ignition system 160. As the gas travels through the gas supply system 150, it is mixed with air and expelled through openings 180 of nozzles 170 shown in more detail in FIGS. 7a-d. The gas ignition system 160, using, for example, a gas pilot light system as known in the art, ignites the mixture of gas and air expelled through the nozzles 170 causing a fire that heats the air inside the heating tubes 130. As the heating tubes 130 get hot, the exhaust escapes through the exhaust pipes 120 and away from the operator of the apparatus 10.

In one exemplary embodiment, the gas supply system 150 may contain an air blower 190 configured to supply air through air valve 200 for mixing with the gas supplied through a safety magnet gas controller 250 and a gas valve 210.

In another exemplary embodiment, the gas ignition system 160 may contain a safety magnet gas controller 260 and a gas valve 270 for supplying gas to a gas pilot light system as known in the art for igniting air and gas mixture expelled through openings 180 of nozzles 170. Should the air blower 190 stop working, a micro switch 290 may be used to shut off the apparatus 10 and the supply of gas using solenoid gas shut off valves 230, 240 and the safety magnet gas controllers 250, 260.

The apparatus 10 may have an on/off switch 220 for turning on the air blower 190 and igniting the air and gas mixtures in the heating assemblies 20 and 30. The apparatus 10 may further have a gas pressure regulator 300 for controlling and/or detecting any spikes in the amount of gas being delivered to the apparatus 10. The apparatus 10 may also have a temperature limit controller 280 for controlling and/or detecting when the temperature is not optimal for cooking.

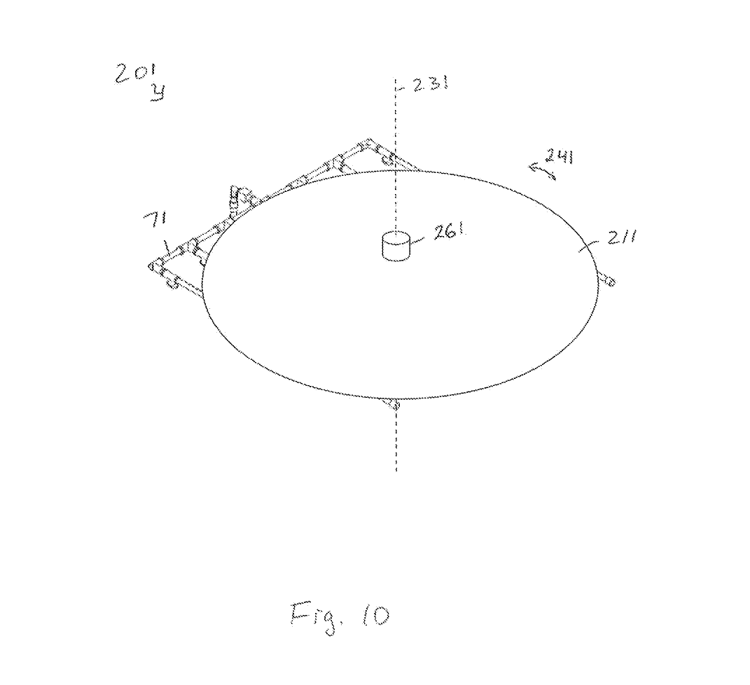

In another exemplary embodiment, apparatus 195 shown in FIG. 9, may be used to prepare food substances and/or food products including, but not limited to, pizza, flat breads, traditional breads, and the like according to the present disclosure. Apparatus 195 may have a heating assembly 201 and a heating assembly 205. Although not shown, one skilled in the art would understand that the apparatus 195 may have a frame for supporting the heating assemblies 201 and 205.

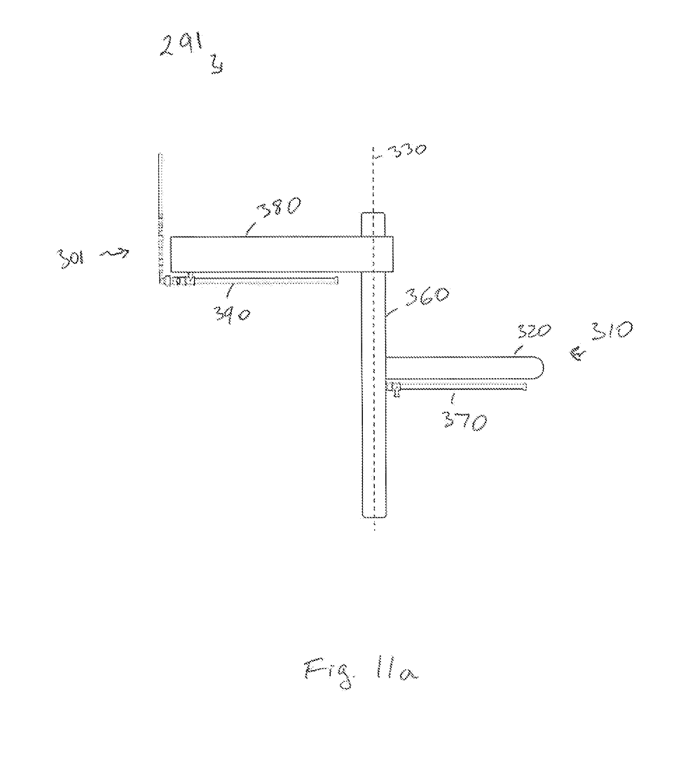

Referring to FIGS. 9 and 10, the heating assembly 201 may contain rotatable support surface 211 for supporting food during the preparation process and heating mechanism 71 dedicated to heating the rotatable support surface 211 as it is rotated about axis 231 in the directions as represented by arrow 241. As described above, the heating mechanism 71 may be any means of heating known to those of ordinary skill in the art including fire, hot coals, infrared, electric, gas, convection and hot air impingement, among others and is possibly thermostatically controlled. In one exemplary embodiment, the heating mechanism 71 is the same as the heating mechanism 70, described in more detail above. In one exemplary embodiment, the rotatable support surface 211 is substantially circular in shape. In another exemplary embodiment, the rotatable support surface 211 is substantially rectangular in shape.

The rotatable support surface 211 may be configured to rotate about the axis 231 using, for example, a post 261 that is rotatably connected with the heating assembly 205. In another exemplary embodiment (not shown), the apparatus 195 may have a frame (not shown) and wheels (not shown) that would support the rotatable support surface 211 and would allow the rotatable support surface 211 to rotate about the axis 231. Although not shown, one skilled in the art would understand that the apparatus 195 may have handles and/or other safety features that would allow a baker to rotate the rotatable support surface 211 without burning their hands.

Referring to FIG. 9, the heating assembly 205 may contain a cover 250 and a heating mechanism 271 configured to heating food product on the rotatable support surface 211 as the rotatable support surface 211 is rotated about axis 231 to position the food product under the heating assembly 205. The heating mechanism 271 may be any means of heating known to those of ordinary skill in the art including fire, hot coals, infrared, electric, gas, convection and hot air impingement, among others and is possibly thermostatically controlled. In one exemplary embodiment, the heating mechanism 271 is the same as the heating mechanism 70, described in more detail above. In another exemplary embodiment, the heating mechanism 271 is the same as the heating mechanism 140, described in more detail above.

In another exemplary embodiment, the heating element 71 may be configured to rotate with the rotatable support surface 211 as the food product is being positioned under the heating element 271.

Having the rotatable support surface 211 be constantly heated by the heating element 71 allows for the most intense and rapid heat transfer to take place as the food product is placed on the rotatable support surface 211. This rapid heat transfer that takes place between the constantly heated rotatable support surface 211 and the food product further results in a reduced bake time and a baking process that effectively causes food substances to start baking from the bottom-up before applying heat from the heating assembly 205.

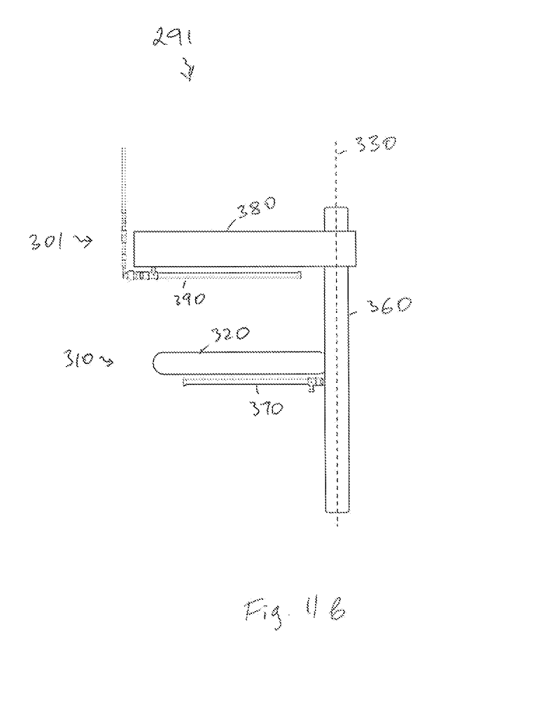

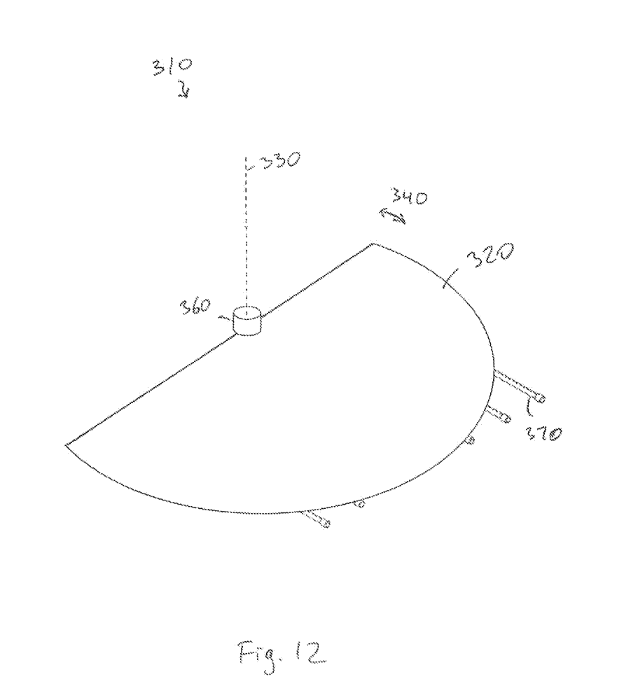

In another exemplary embodiment, apparatus 291 shown in FIGS. 11a-b, may be used to prepare food substances and/or food products including, but not limited to, pizza, flat breads, traditional breads, and the like according to the present disclosure. Apparatus 291 may have a heating assembly 301 and a heating assembly 310. Although not shown, one skilled in the art would understand that the apparatus 291 may have a frame for supporting the heating assemblies 301 and 310.

Referring to FIGS. 11a-b and 12, the heating assembly 310 may contain rotatable support surface 320 for supporting food during the preparation process and a rotatable heating mechanism 370 dedicated to constantly heat the rotatable support surface 320 as they are both rotated about axis 330 in the directions as represented by arrow 340. As described above, the rotatable heating mechanism 370 may be any means of heating known to those of ordinary skill in the art including fire, hot coals, infrared, electric, gas, convection and hot air impingement, among others and is possibly thermostatically controlled. In one exemplary embodiment, the rotatable heating mechanism 370 is the same as the heating mechanism 70, described in more detail above. In one exemplary embodiment, the rotatable support surface 320 is substantially semicircular in shape. In another exemplary embodiment, the rotatable support surface 320 is substantially rectangular in shape.

Referring to FIGS. 11a-b, the rotatable support surface 320 and the rotatable heating mechanism 370 may be configured to rotate about the axis 330 using, for example, a post 360 that is rotatably connected with the heating assembly 301. In another exemplary embodiment (not shown), the apparatus 291 may have a frame (not shown) and wheels (not shown) that would support the rotatable support surface 320 and/or the rotatable heating mechanism 370 and would allow the rotatable support surface 320 and the rotatable heating mechanism 370 to rotate about the axis 330. Although not shown, one skilled in the art would understand that the apparatus 291 may have handles and/or other safety features that would allow a baker to rotate the rotatable support surface 320 and the rotatable heating mechanism 370 without burning their hands.

Referring to FIG. 11, the heating assembly 301 may contain a cover 380 and a heating mechanism 390 configured to heat food product on the rotatable support surface 320 as the rotatable support surface 320 is rotated about axis 330 to position the food product under the heating assembly 300. The heating mechanism 390 may be any means of heating known to those of ordinary skill in the art including fire, hot coals, infrared, electric, gas, convection and hot air impingement, among others and is possibly thermostatically controlled. In one exemplary embodiment, the heating mechanism 390 is the same as the heating mechanism 70, described in more detail above. In another exemplary embodiment, the heating mechanism 390 is the same as the heating mechanism 140, described in more detail above.

Having the rotatable support surface 320 be constantly heated by the rotatable heating mechanism 370 allows for the most intense and rapid heat transfer to take place as the food product is placed on the rotatable support surface 320. This rapid heat transfer that takes place between the constantly heated rotatable support surface 320 and the food product further results in a reduced bake time and a baking process that effectively causes food substances to start baking from the bottom-up before applying heat from the healing assembly 301.

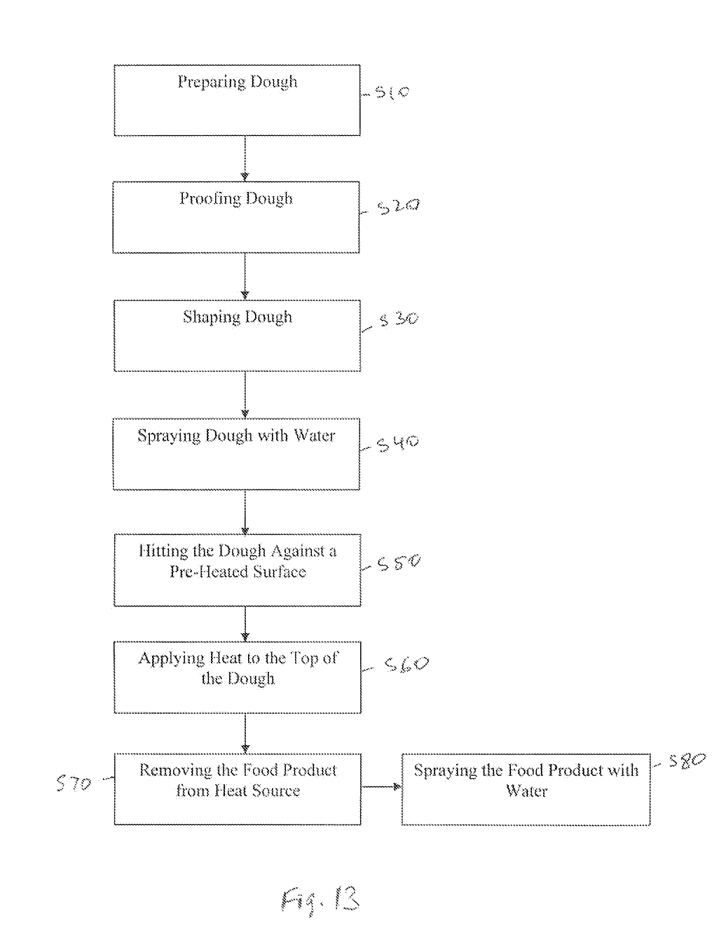

Referring to FIG. 13, the following exemplary process may be used to prepare food substances using any of the apparatuses according to the present disclosure. Referring to step S10, process starts by preparing dough by mixing flour with small amount of water and/or other liquids. Referring to step S20, process may continue by proofing the dough by allowing it to rise. Referring to step S30, process may continue by shaping the dough to have a specific thickness and shape using a dough sheeter and/or hands. Referring to step S40, process may continue by at least partially spraying the dough with water. Referring to step S50, the process continues by hitting the wetted dough against the constantly heated surface, for example, support surfaces 60, 211, 320 described above. Hitting the wetted dough against the constantly heated surface allows for the most intense and rapid heat transfer to take place. This rapid heat transfer that takes place between the constantly heated surface and the food product further results in a reduced bake time and a baking process that effectively causes food substances to start baking from the bottom-up. Referring to step S60, the process continues by applying heat to the top of the dough there by causing the dough to bake from top to bottom. Step S60 may, for example, take about 10-20 seconds. Referring to step S70, the process continues by removing the cooked food product from the heat. Referring to step S80, the process may continue by spraying the food product with water to make it less brittle.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .”

What is claimed is:

1. A device for heating a food product, the device comprising:
a support member for supporting a food product in a first position and a second position;
a first heating mechanism associated with the support member and positioned to heat the support member when the support member is in the first position and in the second position; and
a second heating mechanism positioned to heat the food product when the food product is in the second position.

2. The device of claim 1, wherein the support member and the first heating mechanism are configured to synchronously move between the first position and the second position.

3. The device of claim 1, wherein the support member is configured to at least partially rotate about an axis that is perpendicular to the support member.

4. The device of claim 3, wherein the first heating mechanism is configured to at least partially rotate about the axis.

5. The device of claim 1, wherein the support member is configured to at least partially spin about an axis that is perpendicular to a center of the support member.

6. The device of claim 5, wherein the first heating mechanism is configured to at least partially spin about the axis.

7. The device of claim 1, wherein the support member and the first heating mechanism are configured to synchronously move between the first position and the second position using wheels.

8. A method for preparing a food product, the method comprising:
providing a support member for supporting a food product in a first position and a second position;
providing a first heating mechanism associated with the support member and positioned to heat the support member when the support member is in the first position and in the second position;
providing a second heating mechanism positioned to heat the food product when the food product is in the second position;
preparing dough;
at least partially spraying the dough with water;
placing the dough on the support member when the support member is in the first position;
positioning the support member in the second position;
positioning the support member in the first position;
removing the dough from the support member; and
applying water to the removed dough.
